(19) United States
(12) Patent Application Publication
(10) Pub. No.: US 2013/0153694 A1
(43) Pub. Date: Jun. 20, 2013

(54) Method for Controlling a Mill System Having at Least One Mill, in Particular an Ore Mill or Cement Mill

(71) Applicants: Harald Held, Haar (DE); Michael Metzger, Markt Schwaben (DE); Florian Steinke, Munchen (DE)

(72) Inventors: Harald Held, Haar (DE); Michael Metzger, Markt Schwaben (DE); Florian Steinke, Munchen (DE)

(21) Appl. No.: 13/819,259

(22) PCT Filed: Jul. 22, 2011
(86) PCT No.: PCT/EP2011/062647

§ 371 Date: Feb. 26, 2013

(30) Foreign Application Priority Data
Sep. 2, 2010 (EP) 10009139.6
Apr. 26, 2011 (DE) 102011017504.0

(51) Int. Cl. B02C 25/00; B02C 23/18

(52) U.S. Cl. CPC B02C 25/00; B02C 23/18
USPC 241/15; 241/30; 241/33; 241/36; 241/34

(57) ABSTRACT

A method is disclosed for controlling a mill system having at least one mill, e.g., an ore mill or cement mill, wherein electrical power is drawn from a power network to rotate at least one mill body for comminuting a material fed to the at least one mill body. One or more control variables of the mill system are regulated such that the power drawn from the power network corresponds to a predetermined setpoint power draw-off for the mill system. The method may provide control power in the power network for compensating for fluctuations in energy generation due to increased use of regenerative energies. The method may be used, e.g., to regulate high energy mill systems, e.g., tube mills, SAG mills, or ball mills, such that even relatively large quantities can be made available as control power in the power network.

### CROSS-REFERENCE TO RELATED APPLICATIONS

This application is a U.S. National Stage Application of International Application No. PCT/EP2011/062647 filed Jul. 22, 2011, which designates the United States of America, and claims priority to EP Patent Application No. 10009139.6 filed Sep. 2, 2010 and DE Patent Application No. 10 2011 017 504.0 filed Apr. 26, 2011. The contents of which are hereby incorporated by reference in their entirety.

### TECHNICAL FIELD

The disclosure relates to a method for controlling a mill system as well as a corresponding control device and a corresponding mill system.

### BACKGROUND

Tube mills, such as ball mills or SAG (semi-autogenous grinding) mills, for example, are often used for comminuting coarse-grained material such as ores or cement, for example. For this, the material to be ground is fed to a mill body and the material is comminuted via the rotation of the mill body and by particle impact as well as by friction within the circulating material. Generally in autogenous mills only the material to be ground is fed to the mill body. In addition in SAG mills, steel balls are added to the material to be ground to assist the milling process. Ball mills contain a much higher proportion of steel balls, so that the milling process is principally achieved by the steel balls.

In order to rotate the mill body of the mills described above, electrical energy is required to drive an appropriate electric motor. This energy is drawn from a power supply network. In this case the power required is extraordinarily high and in the case of SAG mills is in the region of up to 30 MW. Generally speaking, ore mills consume approximately 3% of the world's global electrical energy production.

Because of the increase in renewable energy in electrical power generation, fluctuations frequently occur in the electrical power or energy available in a power supply network. There is therefore a need to adapt the energy consumption of large consumers, such as the mills described above, to the amount of energy available in the power supply network.

### SUMMARY

One embodiment provides a method for controlling a mill system having at least one mill, e.g., an ore mill or cement mill, wherein electrical power is drawn from a power supply network for the operation of the mill system, this power being used to rotate at least one mill body, with the result that a material fed to the at least one mill body is comminuted, wherein: a setpoint power draw that is to be drawn from the power supply network is predetermined for the mill system; and one or a plurality of control variables of the mill system is controlled in such a way that the power drawn from the power supply network corresponds to the setpoint power draw.

In a further embodiment, the at least one mill is a tube mill and/or an SAG mill and/or ball mill.

In a further embodiment, the control of the control variable or control variables is realized in such a way that a minimum throughput of milled material and/or a minimum quality of the milled material are obtained.

In a further embodiment, the mill system is intended to provide controlling power to the power supply network, wherein the predetermined setpoint power draw is specified by a predetermined controlling power demand in the power supply network, wherein the control variable or control variables of the mill system are controlled in such a way that the power drawn from the power supply network is reduced by the predetermined controlling power demand.

In a further embodiment, the predetermined controlling power demand is detected by the mill system and/or is signaled to the mill system.

In a further embodiment, the setpoint power draw is specified by a predetermined power range, wherein the control variable or control variables of the mill system are controlled in such a way that the power drawn from the power supply network is within the predetermined power range.

In a further embodiment, one or more of the following variables are controlled as control variables: the rotational speed of the at least one mill body; the quantity of material which is fed to the at least one mill body during its rotation; the quantity of water which is fed to the at least one mill body during its rotation; and the setting of one or more hydrocyclone units used in the mill system.

In a further embodiment, the control variable or control variables are optimized on the basis of an optimization with the optimization goal of lowest possible energy consumption of the mill system per unit of mass of milled material and/or largest possible throughput of milled material and/or highest possible quality of the milled material and/or lowest possible wear of the mill system, wherein a secondary condition of the optimization is that the power drawn from the power supply network corresponds to the setpoint power draw.

In a further embodiment, the at least one or more further secondary conditions are taken into account in the optimization, wherein a further secondary condition, in particular, is that a minimum throughput of milled material and/or a minimum quality of the milled material is obtained.

In a further embodiment, the control of the control variable or control variables is realized with a model predictive controller, which is based on an overall model of the mill and which forecasts one or more operating variables of the mill system in accordance with the change in the control variable or control variables.

In a further embodiment, the overall model is adapted during the operation of the mill system by continuous consideration of operating variables of the mill.

Another embodiment provides a device for controlling a mill system, having at least one mill, in particular an ore mill or cement mill, wherein electrical power is drawn from a power supply network for the operation of the mill system, this power being used to rotate at least one mill body, with the result that material fed to the at least one mill body is comminuted, wherein the device is configured in such a way that, based on a setpoint power draw predetermined for the mill system and to be drawn from the power supply network, one of more control variables of the mill system are controlled in such a way that the power drawn from the power supply network corresponds to the setpoint power draw.

In a further embodiment, the device is configured for implementing any of the methods disclosed above.

Another embodiment provides a mill system having at least one mill, in particular a core mill or cement mill, wherein electrical energy is drawn from a power supply network for the operation of the mill system, this power being used to rotate at least one mill body, with the result that a material fed to the at least one mill body is comminuted, wherein the mill system includes a device as disclosed above.

### BRIEF DESCRIPTION OF THE DRAWINGS

Exemplary embodiments will be explained in more detail below based on the schematic drawings, wherein:

FIG. 1 shows a schematic representation of a mill system having an example control unit, according to one embodiment; and

FIG. 2 shows a block diagram of the example control unit of FIG. 1.

### DETAILED DESCRIPTION

Embodiments of the present disclosure provide methods and control devices for controlling a mill system so that the energy consumption of the mill system is adapted to the power supply network from which the mill system draws electrical power.

Some embodiments may be used to control a mill system having at least one mill, e.g., an ore mill or cement mill, with electrical energy being drawn from a power supply network for the operation of the mill system, this power being used to rotate at least one mill body, with the result that a material fed to the at least one mill body is comminuted. In the context of the disclosed method, a setpoint power draw that is to be drawn from the power supply network is specified for the mill system and one or more control variables of the mill system is controlled in such a way that the (electrical) power drawn from the power supply network corresponds to the setpoint power draw. Here the term setpoint power draw is widely understood and, in addition to a specified power range or a specified power, can also include a corresponding power for a predetermined time interval and therefore also include an energy value or an energy interval. The term power draw can likewise refer to a power for a predetermined time interval and therefore to an energy level. The term setpoint power draw or the power draw can merely concern the power consumption by the mill system, or the setpoint power draw or power draw can also relate to a power consumption of a larger system, which includes the mill system.

The disclosure is based on the idea that the operation of a mill cannot just be optimized internally, but external variables in the form of an appropriately specified setpoint power draw can also be taken into consideration. For example this can ensure that the power draw of the mill system does not exceed a predetermined value or that it lies within a predetermined range, so that it does not result in excessive loading of the power supply network. Equally, the operation of the mill system can be configured in such a way that appropriate controlling power or controlling energy can be made available to the power supply network as is described in more detail below.

The disclosed method may have particular advantages for mill systems having a high power requirement. Some embodiments may thus be employed in a mill system which includes a tube mill and/or an SAG mill and/or a ball mill which have a high electrical energy demand in the order of a few megawatts.

In the context of the disclosed method, in order to make the control dependent not merely upon a setpoint power draw, the control variable or variables are controlled in one variant in such a way that a minimum throughput of the milled material and/or a minimum quality of the milled material are obtained. Here the minimum throughput corresponds to the quantity of milled material produced per unit of time. The minimum quality can be determined in different ways, for example the minimum quality can be specified by a corresponding particle size of the milled material or other properties of the milled material.

In one embodiment of the method, the mill system is used to supply controlling power to the power supply network. Nowadays, short-term controlling power is fed to a power supply network via appropriate power stations, with an energy consumer in the form of a mill system now being used to provide this controlling power. In this case the term controlling power is widely understood and includes not only the true power in the form of energy per unit of time but also, where applicable, power in a predetermined time interval and therefore controlling energy. In the context of the disclosed method, in order to use the mill system to provide controlling power, the predetermined setpoint power draw is specified by a predetermined controlling power demand in the power supply network, with this controlling power demand also being able to represent a power demand for a specified unit of time and therefore a controlling energy demand. In this case, the control variable or variables of the mill system are controlled in such a way that the power drawn from the power supply network is reduced by the predetermined controlling power demand so that the required controlling power is available via the reduction in the energy demand of the mill. The controlling power which usually fluctuates over time can be suitably signaled to the mill system, for example by the operator of the power supply network informing the mill system of the exact, required controlling power demand. If necessary, it is also possible for the mill system itself to detect the controlling power demand in the power supply network using known appropriate detection methods. The controlling power demand can be determined via a reduction in the power-line frequency.

In a further embodiment of the method, the setpoint power draw can also be specified by a predetermined power range, with the control variable or variables being controlled in such a way that the power which is being drawn at least by the mill system and in particular also by other components of an overall plant including the mill system, is within the specified power range. Here the power range can be specified by the power supply network operator and chosen so that no excessive fluctuations occur in the context of the power demand of the mill system. The specified setpoint power range can likewise be stipulated by the operator of the mill system or of the overall plant. For example, when specifying the power range, the operator of the mill system or of the overall plant can take into account appropriate threshold values for the power drawn from the power supply network included in the contracts concluded with the power supply network operator, which usually stipulate severe penalties for exceeding or falling short of these threshold values. The specified power range can then be defined according to the threshold values in order to avoid such penalties.

Those control variables which have a significant influence on the power draw of the mill system are considered as control variables which are controlled in the disclosed method. The control variables may include the rotational speed of the at least one mill body, since this rotational speed determines the electrical power required by the mill system drive and therefore depends to a great extent on the power drawn from the power supply network. In the context of the disclosed control, however, consideration can be given to any other control variables which have an influence on the energy consumption or with which the energy consumption of the mill and therefore the production process can be optimized. In particular, the control variables can include the quantity of material which is fed to the at least one mill body during its rotation. Equally, the amount of water fed to the at least one mill body when rotating can be taken into account during control of the mill system. In tube mills, the milling process usually always takes place with the addition of water.

Furthermore, the adjustment of one hydrocyclone unit or a plurality of hydrocyclone units employed in the mill system can be taken into account. In this case a hydrocyclone unit is used to separate milled material according to particle size, so that such material which has not yet reached the desired particle size is fed again to the mill. The energy demand of the mill and therefore the power draw from the power supply network can be set by appropriate adjustment of the hydrocyclone unit. For example, the separation carried out by the hydrocyclone unit can be varied in such a way that the minimum particle size above which the milled material is no longer fed to the mill is increased. Consequently, energy can be saved since less material is fed back to the mill body.

In one embodiment of the method, the control variable or variables are optimized on the basis of an optimization with the optimization goal(s) of lowest possible energy consumption of the mill system per unit of mass of milled material and/or largest possible throughput of milled material (that is to say largest possible quantity of milled material produced per unit of time) and/or highest possible product quality of the milled material and/or lowest possible wear of the mill system. In this case there is a secondary optimization condition in that power drawn from the power supply network corresponds to the setpoint power draw. As a result, by simply taking a specified setpoint power draw into account, the most optimum operation of the mill system can be achieved on the basis of one or more of the above-mentioned optimization goals. Where a plurality of optimization goals is taken into consideration, the individual optimization goals can be suitably weighted via appropriate weighting factors.

In addition to the above-mentioned secondary condition, one or more further secondary conditions can also still have some influence during optimization with regard to the setpoint power draw. In this case, in one embodiment, the above-mentioned minimum throughput of milled material or the above-mentioned minimum quality of the milled material is considered as a further secondary condition. The further secondary condition is based on the fact that a minimum throughput and/or a minimum quality are obtained.

In one embodiment of the method, the control of the control variable or variables is realized with a known model predictive controller which is based on an overall model of the mill, which predicts one or more of the mill operating variables in accordance with the variation of the control variable or variables. Here model predictive control is known in the art and is not described in further detail.

In one embodiment, a dynamic state-space model which describes the current mill contents, mill energy consumption, as well as the current rate of breaking large particles into finer classifications, is used as the overall model for the model predictive controller. Examples of such models can be found in Rajamani, R. K..; Herbst, J., “Optimal Control of a Ball Mill Grinding Circuit. Part 1: Grinding Circuit Modeling and Dynamic Simulation”, Chemical Engineering Science, 46 (3), 861-870, 1991. Dynamic models allow predictions of how changes in the rotational speed or feed velocity of the material to be milled in the mill affect the overall system (in particular the breaking rate, the energy consumption and the discharge performance of the mill). These models are therefore ideally suited to carrying out a quantitative optimization of the time intervals and the speeds. Furthermore, this makes it possible to calculate rotational speed trajectories instead of fixed setpoints per time interval.

In a further embodiment, the overall model which is taken into account in model predictive control, is adapted during operation of the mill system by continuously taking into account the operating variables of the mill. Other types of controllers can be used instead of or in addition to a model predictive controller. In particular, if necessary, a simple PID controller can be used, which is based on a linear relationship between the change in one or more of the control variables and a resulting change in the power draw from the power supply network.

Other embodiments provide a device for controlling a mill system having at least one mill, with electrical power being drawn from a power supply network, which causes the rotation of at least one mill body, whereby material fed to the at least one mill body is comminuted, with the device being configured in such a way that, based on a setpoint power draw specified for the mill system and which is to be drawn from the power supply network, said device controls a control variable or a plurality of control variables of the mill system so that the power drawn from the power supply network corresponds to the setpoint power draw. In this case the control device may be configured in such a way that one or more variants of the method described above can be realized with the control device.

Other embodiments provide a mill system having at least one mill, in particular an ore mill or cement mill, with electrical power being drawn from a power supply network for the operation of the mill system, this power being used to rotate at least one mill body, with the result that a material fed to the at least one mill body is comminuted. Here the mill system includes the control device described above.

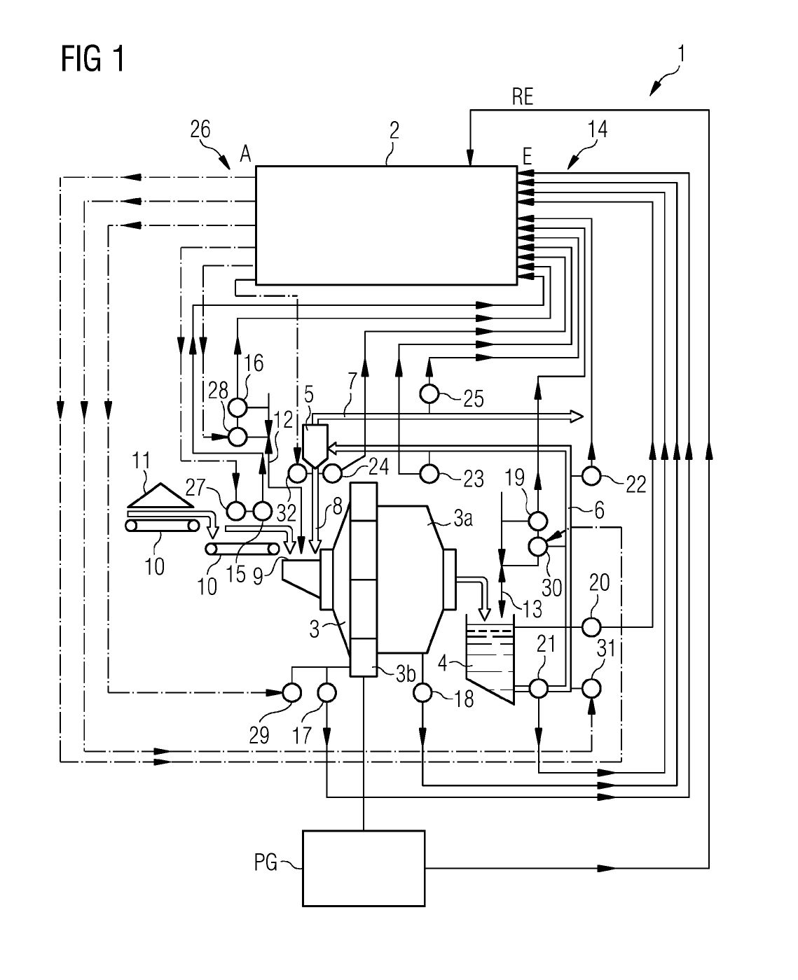

FIG. 1 shows a mill system. The mill system 1 comprises an ore mill embodied as a ball mill or as an SAG mill. It is connected to an adaptive model predictive control unit 2 which controls the operation of the mill system 1. As main components, the mill system 1 includes a central mill 3 having the form of a drum 3a for milling the ore material fed to it, and having, in particular, a gearless electric drive 3b driving the drum 3a. The electric drive and also all other electrically-driven components in the mill system are supplied with electrical power or energy by a power supply network, this power supply network being indicated schematically in FIG. 1 and denoted by the reference mark PG.

The mill 3 concerns a known mill which by the rotation of the drum 3a comminutes ore material located therein. In this case, at low rotational speed of the drum, the ore material forms a cohesive mass (“concentration”), that is to say a large proportion of the ore material is stirred, with ore particles being comminuted by breakdown and gravitational forces. At higher speeds the ore material in the drum begins to tumble (“tumbling”) like a waterfall, that is to say ore particles fly freely through the drum and then impact its walls or previously remaining ore particles, with the ore particles being broken up by the impact. At medium rotational speeds, these two effects can occur simultaneously. At particularly high rotational speeds, the core material is centrifuged, that is to say pressed against the drum wall, with the result that the individual ore particles no longer break up. Both the concentrating and the tumbling of the ore material have specific advantages in relation to comminution, with these advantages depending on the type of the ore to be milled.

Furthermore, in the context of the comminution of ore material in the mill body, water is fed to the material with the result that the broken-up core particles and the water form a slurry or pulp, which then flows through a screen inside the mill body into an output chamber in which radially extending slats or lifters are arranged, which due to the rotation of the mill body rotate about a horizontal axis. At the highest vertical point in the output chamber the pulp falls into a centrally-located hole via which the pulp exits the drum 3a and is fed to a sump unit 4. This sump unit is connected to a known hydrocyclone unit 5 by means of a hydrocyclone supply line 6.

Due to the size of the mill body, whose diameter is usually in the range of several meters (for example 10 m), a very large amount of electrical energy is consumed from the power supply network. In this case, the rotational speed of the mill body and the filling state inside the mill body have a considerable influence on the energy consumption. Up to 30 MW are usually required to drive a ball mill or SAG mill. The mill system can therefore provide controlling power to the power supply network in not inconsiderable amounts as required by correspondingly reducing its energy consumption, for instance by reducing its rotational speed or changing the filling state in the drum. In this example embodiment, the mill system therefore also functions as a unit which delivers controlling power to the power supply network. In order to achieve this, an updated controlling power demand which is denoted by RE in FIG. 1, is communicated to the mill system via the power supply network and is fed to the control unit 2 as an input variable. Based on the controlling power RE, corresponding control variables of the mill system are controlled in such a way that the energy demand of the mill is reduced accordingly, so that the power corresponding to the controlling power demand is available in the power supply network. It is true that this reduction in the energy demand results in a temporary reduction in the production performance of the mill, but due to the provision of controlling power, the mill operator receives financial remuneration from the power supply network operator, which can even be higher than the production losses.

Separation of the delivered material into sufficiently fine-milled material and material which is still too coarse-grained, takes place in the hydrocyclone unit 5. The finely milled material passes into an output-side discharge line 7 that is connected to a component—not shown in detail—connected downstream of the mill system 1. In comparison, the coarse-grained material is fed again via a return line 8 to a feed chute 9 of the central mill 3.

Furthermore, the feed chute 9 is connected to conveyor belts 10 by which non-milled ore material is supplied from an ore store 11. Another feed system can also be provided instead of the conveyor belts 10. Furthermore, the feed chute 9 is connected to a water supply 12. A further water supply 13 is provided at the sump unit 4.

The mill system 1 also contains a large number of measuring sensors which detect measured values for various operating variables B and feed them to the control unit 2 by means of measuring lines 14. For example, a weighing device 15 is provided on the conveyor belts 10, a flowmeter 16 on the water supply 12, a power and torque meter 17 on the drive 3b, a weighing device 18 for detecting the loading of the drum 3a, a flowmeter 19 on the water supply 13, a level meter 20 on the sump unit 4, a particle size meter 21, both a flowmeter 22 and a pressure meter 23 on the hydrocyclone supply line 6, a densimeter 24 on the return line 8 and a particle size meter 25 on the discharge line 7. This list should be regarded as exemplary. In principle, further measuring sensors can be provided. The respective measurements are carried out continuously online and in real time, so that up-to-date measured values are always available in the control unit 2.

In addition to the measuring sensors, the mill system 1 also has a plurality of local controllers which are connected to the control unit 2 by means of control lines 26. In particular, a weight controller 27 is provided on the conveyor belts 10, a flow controller 28 on the water supply 12, a rotational speed controller 29 on the drive 3b, a flow controller 30 on the water supply 13 and on the hydrocyclone supply line 6, a level controller 31 on the sump unit 4 and a density controller 32 on the return line 8.

The stated measuring sensors and local controllers are to be regarded only as exemplary. In individual cases, other components of this type can also be provided. On the conveyor belts, for example, additional information concerning the condition of the supplied non-milled ore material can be obtained by means of laser measurement or video capture. But limitation to only one section of the measuring sensors and local controllers shown in FIG. 1 is also possible.

Moreover, other operating variables which are not accessible to direct measurement can be determined by means of so-called soft sensors. Here recourse is made to detectable primary operating variables from whose measured values a current value of the actual secondary operating variable of interest is determined by means of an evaluation algorithm. The evaluation software used for this can also include a neural network.

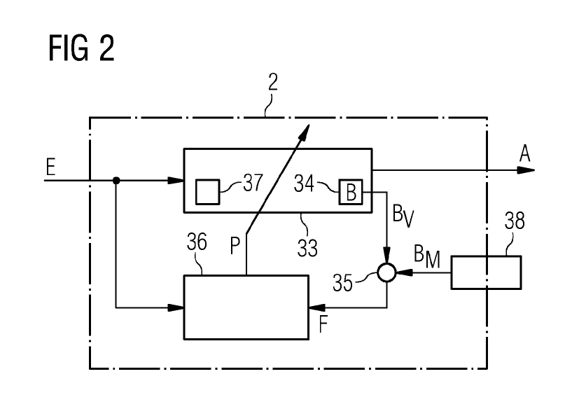

Adjustment of corresponding control variables A of the mill system is realized in the control unit 2—described below in more detail in FIG. 2—in such a way that the necessary controlling power RE is provided in the power supply network PG and, furthermore, ensures the most optimal operation of the mill system. The control variables A controlled by the control unit 2 have an effect on various state variables of the mill which are related to the energy consumption. In the embodiment described here, the control variables influence the rotational speed of the mill body via a corresponding rotational speed controller, as well as the supplied quantity of ore to be milled, via a corresponding conveyor belt speed controller (not shown in FIG. 1). If necessary, further control variables which have an effect on the power, can also be included. For example, the hydrocyclone unit 5 can be controlled so that the material is less finely milled. This does of course reduce the product quality, but the consumed power is also reduced, so that controlling power is available for the power supply network. In the context of the control—as described below—since a minimum product quality can be included as a secondary condition, it is therefore possible to always ensure a minimum quality of the milled material by varying the settings of the hydrocyclone unit.

Input variables E representing the operation of the mill, from which suitable control variables are determined via a known model predictive control, are processed in the control unit 2. In the embodiment described here, the control is based on an optimization having the optimization goal of a lowest possible specific energy consumption of the mill system, that is to say a lowest possible energy consumption per unit mass of milled material. This specific energy consumption can be appropriately determined in the mill system via acquired measured values.

If applicable, lowest possible wear of the mill system can be included as a further optimization goal, whereby appropriate measuring parameters can likewise be enlisted to determine wear. In particular, the wear depends on the filling state and the rotational speed of the mill body. With certain rotational speeds and filling states, the tumbling motion performance of the ore material is higher, which leads to higher wear. In this case, corresponding relationships between rotational speed or filling state and the impact of the ore particles are known, so that a corresponding value for wear can be determined. At the same time, if necessary, wear can also be appropriately determined for other components of the mill system via acquired state variables.

In the context of control by the control unit 2, it is important that during optimization, the corresponding controlling power demand or controlling energy demand RE is included as a secondary condition to be maintained, that is to say the control is realized in such a way that the power of the mill system is adjusted so that the corresponding controlling energy or controlling power is available in the power supply network. In this connection, in one variant further secondary conditions take into account that a predetermined minimum product quality of the milled material or a predetermined minimum throughput is achieved, so that the mill is always efficiently operated. The throughput, that is to say the amount of milled material produced per unit of time, or the product quality, can in turn be measured or determined via corresponding measured values, such as the particle size of the milled material, for example.

FIG. 2 shows a block diagram of the control unit 2 with its main components. It includes an adaptive overall model 33 of the mill system 1, a predictive unit 34, a comparator unit 35, a parameter identification and adaptation unit 36, as well as an optimization unit 37. These components are realized, in particular, as software modules.

A measuring unit 38, which is representative of the large number of measuring sensors reproduced in the figure, is included in the block diagram of FIG. 2. If configured as a soft sensor, the measuring unit 38 can also be realized as a software module and therefore as an integral component part of the control unit 2. But otherwise it is equally possible for the measuring unit 38 to be modules that are physically separated from the control unit 2.

The mode of operation of the control unit 2 is described in detail below.

As already mentioned, various input variables E are fed to the input side of the control unit 2. In this case, this concerns measured values but also other operating data. Possible input data E are the weight of ore, the hardness of the ore material to be milled, the water supply to the water feeds 12 and 13, the material return flow from the hydrocyclone unit 5 to the input 9 of the central mill 3, particle size distributions at various points within the mill system 1, in particular in the sump unit 4 or in the output-side discharge line 7, geometrical data of the central mill 3, the speed at which the conveyor belts 10 feed the material to be milled to the input 9, and a speed at which the end product, that is the milled material, is fed to the subsequent components. The input variables E can therefore refer to process parameters, to the design of the mill system 1, above all the central mill 3 or to the material. Furthermore, as input variable, the control unit 2 receives a controlling power demand RE that is signaled by the power supply network. If necessary, the mill system itself can also detect the controlling power demand, for example on the basis of a change in power line frequency.

As described above, the control unit 2 determines output variables A which are control variables for controlling the process sequence. These control variables can represent variables which act directly on actuating elements, that is to say without interposition of local controllers. Equally, the control variables can represent corresponding reference input variables for the various local controllers, as shown in FIG. 1.

The adaptive overall model 33 of the control unit 2 describes the mill system 1 in its entirety. It is composed of a coupling of a plurality of submodules. The submodules describe the central mill 3, the sump unit 4 and the hydrocyclone unit 5. Further submodules for other components of the mill system 1 can be added as required. The adaptive overall model 33 can be matched to the current prevailing process conditions by means of model parameters P—whether or not this adaptation is realized by means of all parts or only one part of the model parameters P also being determined in the parameter identification and adaptation unit 36. If necessary, a relevant sub-block of the model parameters P is therefore identified. The model parameters P selected in this way are then especially suitable for model adaptation. The adaptive overall model 33 is based on physical inputs which can also be supplemented, at least partially, by empirically established data. The adaptive overall model 33 and, in particular, its adaptation by means of the model parameters P, are computed in real time. This contributes to the fact that no significant control dead-times occur.

Using the overall model 33, a known model predictive control is realized by means of the optimization unit 37 and the prediction unit 34. In this case, operating variables B can be predicted by the overall model in relation to the input variables and changes in control variables, with the control variables being adjusted so that the optimization goal is achieved, based on a corresponding optimization algorithm using the predicted operating variables. Here the optimization goal is to ensure lowest possible specific energy consumption. If necessary, further optimization goals can be considered, such as lowest possible wear in the mill system, for example. The corresponding controlling power demand or controlling energy demand RE is included as a secondary condition. That means that the optimization is configured in such a way that in all events the required control power or control energy demand is provided to the power supply network by corresponding changes in the control variables. The optimization goal may be represented by an appropriately minimized cost function.

Further conceivable secondary conditions follow from the physical, technological or process-dependent limits. They can be entered directly into the optimization algorithm, so that a set of control or reference input variables which would lead to an unstable process sequence, is eliminated from the outset. According to a well-founded procedural economical secondary condition, it can be demanded that the density in the return line 8 does not exceed eighty percent, since otherwise the separation efficiency in the hydrocyclone unit 5 clearly falls due to modified rheology. Furthermore, the rotational speed of the drum 3a can be limited in order to avoid excessive centrifugal forces. Equally, there are maximum and minimum values for the pumping capacity at the fresh water supply and also at the non-milled core material feed. Limits for the maximum loading state of the drum 3a should also be taken into consideration.

The consideration of secondary conditions also helps the set operating mode of the mill system 1 to meet a plurality of requirements equally. For example, the mill speed, the fresh water supply in the central mill 3 and in the sump unit 4, as well as the energy consumption can be optimized in this way, with at the same time the throughput and the achieved product quality being maintained at a predetermined level.

On the one hand, the operating variables predicted by the prediction unit 34 are processed by the optimization unit 37. Furthermore, the predicted operating variables are also used for the adaptation of the overall model 33. For this, the corresponding forecast values B_{V} of the operating variables are fed to the comparator unit 35, which compares the forecast value with the measured value B_{M} of the corresponding operating variable. An established deviation F is made available to the parameter identification and adaptation unit 36 for determining an improved data record for the model parameters P. The set model parameters P improved in this way are then enlisted for adaptation of the adaptive overall model 33. The adapted overall model 33 is then used for determining the output variables A and also the forecast value B_{V} for a future operating phase. Since the control unit 2 is based on a prognosis of the value which the operating variable B will adopt in future, control dead-times are largely inapplicable. On the one hand the control unit 2 is therefore very stable and on the other hand reacts very rapidly to changed process conditions.

Various variables of the mill system 1 such as flow rate, density, weight, pressure, power, torque, speed, graininess or even particle size distribution, for example, are conceivable as operating variables B. Here, in particular, a section of the input variables E is involved. The particle size distribution above all is particularly suitable for determining an improved parameter set for the model parameters P.

The parameter identification and adaptation unit 36 employs a mathematical optimization method, such as Sequential Quadratic Programming (SQP), in which a predetermined objective function meeting secondary conditions is minimized and is used to determine the improved parameter (sub-) block for the model parameters P. The minimization of the objective function and therefore the parameter adaptation are undertaken in the parameter identification and adaptation unit 36, so that the adapted overall model 33 simulates as closely as possible the past performance of the mill system 1. A value B_{R} of the operating variable B, calculated with the overall model 33 adapted in this way for the former operating phase (=for at least one previous cycle), would differ minimally from the acquired measured value B_{M}. The adapted overall model 33 optimally describes the reality in the past with this adapted parameter set.

The deviation between measured and calculated particle size distribution, for example, can be considered as an objective function. Possible secondary conditions then follow, in particular, from a transition matrix whose coefficients indicate the probability of a material particle, which occurs in the current cycle in a specific partial sub-domain of the particle size distribution, occurring after the next cycle in a (different) specific sub-domain of the particle size distribution. The values which can assume the coefficients of this transition matrix underlie known, mathematically or physically dependent limitations. Limits for the individual coefficients, but also for combinations, for example for totals of a plurality of coefficients, can be stated.

Equally, the objective function but also the deviation between measured and calculated densities in the return line 8 can be defined. A combination of a plurality of objective functions can of course also be enlisted for the optimization in the parameter identification and adaptation unit 36.

The above explanations have been given as an example of an ore mill. However, the described principles and advantageous operating modes can be readily applied to the operation of other types of mills, such as cement mills, or mills used in the pharmaceutical industry, for example.

What is claimed is:

1. A method for controlling a mill system having at least one ore mill or cement mill, wherein electrical power is drawn from a power supply network and supplied to the mill system to rotate at least one mill body to comminute a material fed to the at least one mill body, the method comprising:
predetermining a setpoint power draw to be drawn from the power supply network; and
using a controller to control one or more control variables of the mill system such that a power drawn from the power supply network corresponds to the predetermined setpoint power draw.

2. The method of claim 1, wherein the at least one mill comprises at least one of a tube mill, an SAG mill, and a ball mill.

3. The method of claim 1, comprising controlling the one or more control variables to obtain at least one of a minimum throughput of milled material and a minimum quality of the milled material.

4. The method of claim 1, wherein:
the mill system provides controlling power to the power supply network,
the predetermined setpoint power draw is specified by a predetermined controlling power demand in the power supply network, and
the one or more control variables of the mill system are controlled such that the power drawn from the power supply network is reduced by the predetermined controlling power demand.

5. The method of claim 4, wherein the predetermined controlling power demand is at least one of (a) detected by the mill system and (b) signaled to the mill system.

6. The method of claim 1, wherein the setpoint power draw is specified by a predetermined power range, and wherein the one or more control variables of the mill system are controlled such that the power drawn from the power supply network is within the predetermined power range.

7. The method of claim 1, comprising controlling one or more of the following variables as control variables:
a rotational speed of the at least one mill body;
a quantity of material fed to the at least one mill body during a rotation of the at least one mill body;
a quantity of water fed to the at least one mill body during a rotation of the at least one mill body; and
a setting of one or more hydrocyclone units used in the mill system.

8. The method of claim 1, comprising optimizing the one or more control variables based on at least one of the following optimization targets:
a lowest possible energy consumption of the mill system per unit of mass of milled material, a largest possible throughput of milled material, a highest possible quality of the milled material, and a lowest possible wear of the mill system,
wherein a secondary condition of the optimization specifies that the power drawn from the power supply network corresponds to the setpoint power draw.

9. (canceled)

10. The method of claim 1, wherein the one or more control variables are controlled using a model predictive controller, which is based on an overall model of the mill and which forecasts one or more operating variables of the mill system based on changes in the one or more control variables.

11. The method of claim 10, comprising adapting the overall model during an operation of the mill system by continuous consideration of operating variables of the mill.

12. The device for controlling a mill system, having at least one ore mill or cement mill, wherein electrical power is drawn from a power supply network and supplied to the mill system to rotate at least one mill body to comminute material fed to the at least one mill body, the device comprising:
a controller configured to control one or more control variables of the mill system based on a predetermined setpoint power draw for the mill system such that a power drawn from the power supply network corresponds to the setpoint power draw.

13-14. (canceled)

15. The device of claim 12, wherein the controller is configured to control the one or more control variables to obtain at least one of a minimum throughput of milled material and a minimum quality of the milled material.

16. The device of claim 12, wherein:
the mill system provides controlling power to the power supply network,
the predetermined setpoint power draw is specified by a predetermined controlling power demand in the power supply network, and
the controller is configured to control the one or more control variables such that the power drawn from the power supply network is reduced by the predetermined controlling power demand.

17. The device of claim 16, wherein the predetermined controlling power demand is at least one of (a) detected by the mill system and (b) signaled to the mill system.

18. The device of claim 12, wherein the setpoint power draw is specified by a predetermined power range, and wherein the controller is configured to control the one or more control variables such that the power drawn from the power supply network is within the predetermined power range.

19. The device of claim 12, wherein the controller is configured to control one or more of the following variables as control variables:
a rotational speed of the at least one mill body;
a quantity of material fed to the at least one mill body during a rotation of the at least one mill body;
a quantity of water fed to the at least one mill body during a rotation of the at least one mill body; and
a setting of one or more hydrocyclone units used in the mill system.

20. The device of claim 12, wherein the controller is configured to control the one or more control variables based on at least one of the following optimization targets: a lowest possible energy consumption of the mill system per unit of mass of milled material, a largest possible throughput of milled material, a highest possible quality of the milled material, and a lowest possible wear of the mill system,
wherein a secondary condition of the optimization specifies that the power drawn from the power supply network corresponds to the setpoint power draw.

21. A mill system, comprising:
at least one mill body,
a power supply network configured to supply power to rotate the at least one mill body to comminute material fed to the at least one mill body, and
a controller configured to control one or more control variables of the mill system based on a predetermined setpoint power draw for the mill system such that a power drawn from the power supply network corresponds to the setpoint power draw.
